(19) United States
(12) Patent Application Publication
(10) Pub. No.: US 2007/0213456 A1
(43) Pub. Date: Sep. 13, 2007

(54) One-step process for rapid structure repair

(76) Inventors: Rina Singh, Westerville, OH (US); Robert B. Fechter, Worthington, OH (US)

Correspondence Address: David L. Hedden, Attorney;Ashland Licensing and Intellectual Property LLC, 5200 Blazer Parkway, Dublin, OH, 43017, US

(21) Appl. No.: 11/438,694

(22) Filed: May 22, 2006

Related U.S. Application Data
(60) Provisional application No. 60/683,619, filed on May 23, 2005.

(51) Int. Cl. C08K 3/34; C08G 18/08

(52) U.S. Cl. 524/589; 524/442

(57) ABSTRACT

This invention, relates to a one-step process for rapidly repairing structures. The process uses a binder comprising a polyisocyanate-terminated pre-polymer containing a divalent metal catalyst, and preferably a tertiary amine catalyst, which cures in the presence of moisture.

### CLAIM TO PRIORITY

This application claims the benefit of U.S. provisional application No. 60/683,619 filed on May 23, 2005, the contents of which are hereby incorporated into this application.

### TECHNICAL FIELD

This invention relates to a one-step process for rapidly repairing structures. The process uses a binder comprising a polyisocyanate-terminated pre-polymer containing a divalent metal catalyst, and preferably a tertiary amine catalyst, which cures in the presence of moisture.

### BACKGROUND

The Air Force and other services have critical needs for technology for the rapid construction, repair, and safe operation of airbases. One of the problems involved in carrying out such activities is the presence of moisture in or around the structure to be repaired.

Typically, solvent-based binders, usually as two-component binders, are used in bonding aggregates. These binders are typically based on phenolic-urethane chemistry. Most commonly, such binders contain a large amount of solvents, usually 40 to 50 weight percent. The solvents are usually aromatic hydrocarbons, such as toluene, xylene, and others. For instance, see U.S. Pat. Nos. 6,130,268 and 5,872,203, and DE 29,920,721.

All citations referred to in this application are expressly incorporated by reference.

### BRIEF DESCRIPTION OF THE FIGURES

FIG. 1 shows the effect of the percent binder on compressive strengths of cores.

FIG. 2 shows the effect of the percent binder on compressive strengths of cores.

FIG. 3 shows the effect of the weight percent binder on the flexural strengths of cores.

FIG. 4 shows the effect of water on the compressive strengths of cores.

FIG. 5 shows the effect of water on the flexural strengths of cores.

### SUMMARY

This invention relates to a one-step process for rapidly repairing structures. The process uses a binder comprising a polyisocyanate-terminated pre-polymer containing a divalent metal catalyst, arid preferably a tertiary amine catalyst, which cures in the presence of moisture.

The process is particularly useful for rapid construction and repair, e.g. airfield damage repair applications, crater repair, pothole repair, bridge, repair, road repair, and ramp repair. Although the binders used in the process can be used neat, they are typically mixed with aggregate or indigenous materials available at the site where the repair is needed. The binders used in the process have good shelf stability and excellent bonding strength to aggregates in presence of moisture.

The structures formed by carrying out the process have excellent water resistance, flexural strength, and compressive strength. These binders used in the one-step process cure rapidly in presence of moisture, e.g. water, atmospheric moisture. Additionally, the binder used is preferably solvent-free. And because the process only involves one step, the process can be carried out with simplicity and minimal labor cost.

The binders used in the process provide advantages over other polyurethane binders because they cure in the presence of high levels of water without degradation of strength properties. It is known that most polyurethane systems tend to lose mechanical performance in presence of moisture.

### DETAILED DESCRIPTION

The polyisocyanate pre-polymers used in the process are the reaction products of an excess of organic polyisocyanate and an active hydrogen-containing compound. Although primary and secondary amines can be used as the active hydrogen-containing compound to prepare the pre-polymer, preferably the active hydrogen-containing compound is a compound having hydroxyl group with a functionality of at least 2.0. The pre-polymers are prepared by methods well known to those of ordinary skill in the art. The amount of free isocyanate in the polyisocyanate pre-polymer typically ranges from 1 to 30, preferably from 9 to 18, and most preferably from 12 to 14 percent free NCO content. A tertiary amine catalyst is preferably added to the pre-polymers to promote their reaction with moisture.

The polyisocyanate pre-polymer is prepared by reacting the organic polyisocyanate with typically from 1 to 50 weight percent, preferably from 35 to 48 weight percent, of a compound having active hydrogen-containing groups, preferably free hydroxyl groups, where said weight percent is based upon the weight percent of the organic polyisocyanate. Typical compounds having free hydroxyl groups include polyhydric alcohols (e.g. glycols), phenolic resole resins, polyolefin polyols, polycarbonate polyols, polyester polyols, polyether polyols, and mixtures thereof.

The general procedure for preparing the polyisocyanate pre-polymer involves heating the hydroxyl-containing compound in the presence of the organic polyisocyanate until all of the active hydrogen-containing groups have reacted in the presence of a divalent metal catalyst. Examples of divalent metal catalysts include compounds having a divalent metal ion such as zinc, lead, manganese, copper, tin, magnesium, cobalt, calcium, or barium. Specific examples include dibutyltindilaurate stannous octoate, dibutyltin diacetate, and stannous oleate. Particularly useful is dibutyltindilaurate. The divalent metal catalyst is typically added to the pre-polymer in an amount of from 0.01% to 1.0% by weight of the pre-polymer, preferably about in a range between 0.01 to 0.5%. The mixture is typically heated to a temperature of about 50° C. for about two hours. The divalent metal catalyst remains in the formed pre-polymer.

The tertiary amine catalysts are liquid tertiary amines. Examples include 4-alkyl pyridines wherein the alkyl group has from one to four carbon atoms, isoquinoline, arylpyridines such as phenyl pyridine, pyridine, acridine, 2-methoxypyridine, pyridazine, 3-chloro pyridine, quinoline, N-methyl imidazole, N-ethyl imidazole, 4,4′-dipyridine, 4-phenylpropylpyridine, 1-methylbenzimidazole, and 1,4-thiazine. Preferably used as the liquid tertiary amine catalyst is an aliphatic tertiary amine, particularly [tris(3-dimethylamino)propylamine]. Preferably used as the tertiary amine are 2,2′-dimorpholinodiethylether and N,N′-dimethylpiperazine.

The amount of tertiary amine catalyst used is typically from 0.01 to 1.0 parts by weight, preferably from 0.01 to 0.5 parts by weight, most preferably from 0.1 to 0.25 parts by weight.

The organic polyisocyanate used to prepare the organic polyisocyanate pre-polymer is an organic polyisocyanate having a functionality of two or more, preferably 2 to 5. It may be aliphatic, cycloaliphatic, aromatic, or a hybrid polyisocyanate. Mixtures of such polyisocyanates may be used. Representative examples of organic polyisocyanates are aliphatic polyisocyanates such as hexamethylene diisocyanate, alicyclic polyisocyanates such as 4,4′-dicyclohexylmethane diisocyanate, and aromatic polyisocyanates such as 2,4′-diphenylmethane diisocyanate and 2,6-toluene diisocyanate, and dimethyl derivatives thereof. Other examples of suitable organic polyisocyanates are 1,5-naphthalene diisocyanate, triphenylmethane triisocyanate, xylylene diisocyanate, and the methyl derivatives thereof, polymethylenepolyphenyl isocyanates, chlorophenylene-2,4-diisocyanate, and the like. The organic polyisocyanate is used in a liquid form. Solid or viscous polyisocyanates must be used in the form of organic solvent solutions, the solvent generally being present in a range of up to 80 percent by weight of the solution.

It may be useful in some cases to blend the pre-polymer with an organic polyisocyanate. If an organic polyisocyanate is blended with the organic polyisocyanate pre-polymer, the amount of organic polyisocyanate blended is from 1 to about 10 percent by weight, based upon the weight of the organic polyisocyanate pre-polymer.

Typical compounds having free hydroxyl groups include polyhydric alcohols (e.g. glycols), phenolic resole resins, polyolefin polyols, polycarbonate polyols, polyester polyols, polyether polyols, and mixtures thereof.

Polyhydric alcohols include ethylene glycol, propylene glycol, diethylene glycol, 1,4-butanediol, neopentyl glycol, 1,6-hexanediol, cyclohexane dimethanol, glycerol, trimethylolpropane, and pentaerythritol.

The polyether polyols are liquid polyether polyols generally having hydroxyl numbers from about 200 to about 1,000, more preferably from 300 to 800, and most preferably from 300 to 600 milligrams of KOH based upon one gram of polyether polyol. The viscosity of the polyether polyol is from 100 to 1,000 centipoise, preferably from 200 to 700 centipoise, most preferably 300 to 500 centipoise. The hydroxyl groups of the polyether polyols are preferably primary and/or secondary hydroxyl groups.

The polyether polyols are prepared by reacting an alkylene oxide with a polyhydric alcohol in the presence of an appropriate catalyst such as sodium methoxide according to methods well known in the art. Representative examples of alkylene oxide include ethylene oxide, propylene oxide, butylene oxide, amylene oxide, styrene oxide, or mixture thereof. The polyhydric alcohols typically used to prepare the polyether polyols generally have a functionality greater than 2.0, preferably from 2.5 to 5.0, most preferably from 2.5 to 4.5. Examples include ethylene glycol, diethylene glycol, propylene glycol, trimethylol propane, glycerin, and pentaerythritol.

Phenolic resins, which can be used as the polyol, include phenolic resole resins, preferably polybenzylic ether phenolic resins. The phenolic resole resin is prepared by reacting an excess of aldehyde with a phenol in the presence of either an alkaline catalyst or a divalent metal catalyst according to methods well known in the art. Solvents, as specified, are also used in the phenolic resin component along with various optional ingredients. The polybenzylic ether phenolic resin is prepared by reacting an excess of aldehyde with a phenol in the presence of a divalent metal catalyst according to methods well known in the art. They preferably contain a preponderance of bridges joining the phenolic nuclei of the polymer which are ortho-ortho benzylic ether bridges. They are prepared by reacting an aldehyde and a phenol in a mole ratio of aldehyde to phenol of at least 1:1, generally from 1.1:1.0 to 3.0:1.0 and preferably from 1.1:1.0 to 2.0:1.0, in the presence of a metal ion catalyst, preferably a divalent metal ion such as zinc, lead, manganese, copper, tin, magnesium, cobalt, calcium, or barium.

Preferably used as the hydroxyl-containing compound to prepare the polyisocyanate pre-polymers are liquid polyester polyols having a hydroxyl number from about 500 to 2,000, preferably from 700 to 1200, and most preferably from 250 to 600; a functionality equal to or greater than 2.0, preferably from 2 to 4; and a viscosity of 500 to 50,000 centipoise at 25° C., preferably 1,000 to 35,000, and most preferably 2,000 to 25,000 centipoise. They are typically prepared by ester interchange of ester and alcohols or glycols by an acidic catalyst. The amount of the polyester polyol in the polyol component is, from 2 to 50 weight percent, preferably from 10 to 35 weight percent, most preferably from 10 to 25 weight percent based upon the polyol component.

Preferably used as the polyester polyol are aromatic polyester polyols. These are prepared by the ester interchange of an aromatic polyester such as phthalic anhydride based polyester and polyethylene terephthalate with a polyhydric alcohol such as ethylene glycol, diethylene glycol, triethylene glycol, 1,3-propanediol, 1,4-butanediol, dipropylene glycol, tripropylene glycol, tetraethylene glycol, glycerin, and mixtures thereof. Examples of commercial available aromatic polyester polyols are Lexorez 1102-60, Lexorez-1640-150, Lexorez Resins manufactured by Inolex Corp.

In some applications, it may be useful to add an inhibitor to retard the curing rate of the binder, which improves the storage stability of the pre-polymer. Typical inhibitors include benzoyl chloride, monophenyldichlorophosphate, phosphorus oxychloride, phthaloyl chloride, benzenephosphorus oxydichloride, and the like.

Conventional defoamers, such as D-1400 (from Dow Corning), may also be added to the binder to promote homogeneous mix and faster reaction during the preparation of the binder.

Any aggregate can be used in connection with the binder. The aggregate may be an aggregate shipped to the site where the space is to be filled or some indigenous material found at the site. Examples of aggregate include sand, zircon, alumina-silicate sand, chromite sand, fly ash, pea gravel, grit, particles of stone, sandstone, clay, crushed concrete, etc. The aggregate is typically used in amounts of 5 to 95 weight percent based upon the total weight of the binder and aggregate.

The process is most simply carried out by adding the neat binder to the space to be filled in an amount to sufficiently fill the space and make it useful for its normal purpose. In some situations, it may be advantageous to add aggregate to the space to be filled and/or the binder before adding the binder to the space to be filled, and in another instance, the aggregate is mixed with the binder and both binder/aggregate are added to fill the space.

The amount of the binder can vary over wide ranges depending upon the specific application. Typically the level of binder ranges from about 5 parts by weight to about 50 parts by weight, preferably from about 25 parts by weight to about 35 parts by weight, where said parts by weight are based upon the parts by weight of the aggregate if an aggregate is used.

Abbreviations

ISOSET® UX 100 a polyisocyanate pre-polymer, sold commercially by Ashland Specialty Chemical Company, a division of Ashland Inc., having a free NCO content of about 15 to 20 weight percent prepared by reacting a polyether polyol with MDI.

PLIODECK® PVC a polyisocyanate pre-polymer, sold commercially by Ashland Specialty Chemical Company, a division of Ashland Inc., having a free NCO content of about 10 to 15 weight percent prepared by reacting an aromatic polyester polyol with MDI, which also contains from about 0.1 to about 1.0 weight percent of a tertiary amine catalyst, which was a mixture comprising a major amount of of 2,2′-dimorpholinodiethylether (DMDEE) and a minor amount of N,N′-dimethylpiperazine (DMP), based upon the weight of the polyisocyanate pre-polymer.

### EXAMPLES

The following examples will illustrate some specific ways to carry out this invention. These examples are merely illustrative and not intended to be exhaustive of all embodiments within the scope of the claims. In the examples, all units are in the metric system and all amounts and percentages are by weight, unless otherwise expressly indicated.

### Example 1

A one-component ISOSET® U100 polyisocyanate pre-polymer binder was added to Manley 1L-5W sand in presence of constant moisture (1 weight percent water) at binder levels of 10 weight percent and 20 weight percent. The water was added to the dry sand and mixed for 1 minute and then the binder was added to the wet sand and mixing was continued for another 2 minutes. The resulting mixture was added to a 1 inch height by 1 inch diameter tube which had a silicone release liner. After 24 hours, the specimen was removed from the tube and compressive strength was determined. Compressive strength was determined using the test method described in ASTM C579-96. The test method covers compressive strength of chemical resistant mortars, grouts, monolithic surfacings, and polymer concrete.

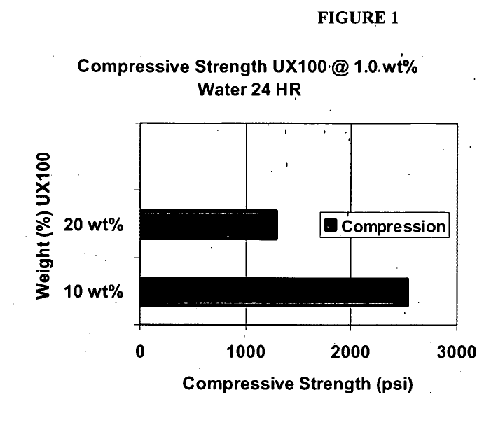

FIG. 1 shows the compressive strength for the 10 and 20 weight percent binder as 2539 psi and 1286 psi, respectively at 24 hours. The data indicate that the compressive strength decreases with increasing amount of binder above 10 weight percent, which is probably a result of the binder reaching its optimum strength at 1.0 weight percent water content and 10 weight percent binder.

### Example 2

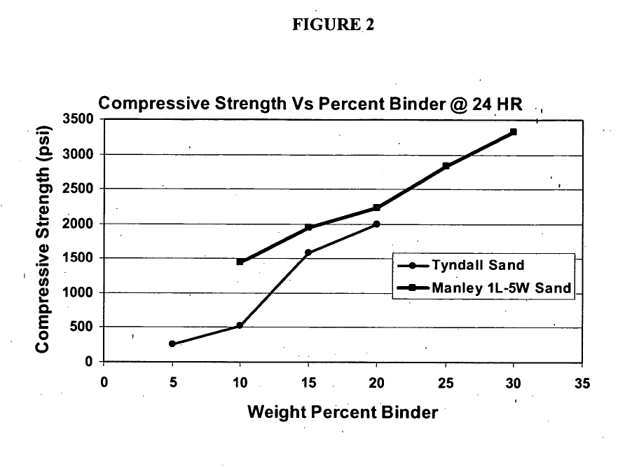

Example 1 was repeated except the binder, PLIODECK® PVC, was added to wet Tyndall sand (a silica sand obtained from Florida in the vicinity of the United States Tyndall Air Force Base and characterized as having AFS GFN 57.93, pH of 6.4, and a moisture content ranging from 1 to 2 weight percent) and wet Manley 1L-5W sand in increasing amounts. In the instance of Manley 1L-5W sand, a known amount of water (1 weight percent) was added to it prior to adding the binder. Tyndall sand contained approximately 1.4 weight percent water. The Tyndall sand was pre-dried at 100° C. for 24 hours to remove the moisture prior to using. PLIODECK® PVC was added to sand at binder levels of 5, 10, 15, 20, 25, 30 weight percent. The compressive strengths at 24 hours were then measured and plotted graphically as indicated in FIG. 2, which indicates that compressive strength increases with increasing binder on both sands.

The data in Examples 1 and 2 indicate that the compressive strength increases with increasing level of binder at a constant concentration of water on both aggregates. The binder strength is dependent on the polymer backbone. The data indicates that both binders cure in presence of moisture and produce structures with adequate strengths rapidly. This is unusual because most polyurethane binder systems traditionally lose their mechanical strength in presence of moisture.

A comparison of the data in Examples 1 and 2 also show the advantages of using the tertiary amine as a catalyst in the pre-polymer.

### Example 3

The procedure of Example 2 was followed and the flexural strength was determined for two levels of binder, namely 15 and 25 weight percent on Manley 1L-5W with 1.0 weight percent water at 24 hours. The water was added to the sand and mixed for 1 minute and then the binder was added to the wet sand and mixing continued for another 2 minutes. The resulting mixture was added to a 1×1×10 inch aluminum mold. After 24 hours, the 1×1×10 inch bar was removed from the mold and flexural strength was determined. Flexural strength was determined using the test method described in ASTM C580-93. The test method covers the determination of flexural strength and modulus of elasticity in flexure of cured chemical-resistant materials in the form of molded rectangular beams. These materials include mortars, brick and tile grouts, structural grouts, machinery grouts, monolithic surfacings, and polymer concrete.

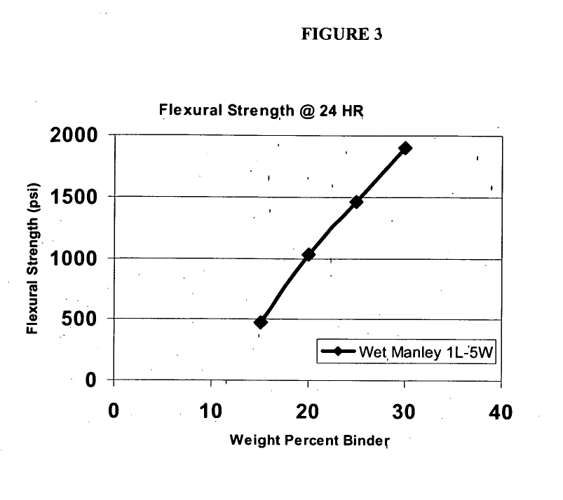

FIG. 3 shows an increase in flexural strength as the amount of binder was increased. The flexural strength increases with increasing binder level at a constant known amount of moisture content. This is a result of the polymer backbone, which probably is undergoing further crosslinking with increasing binder concentration in presence of moisture.

### Example 4

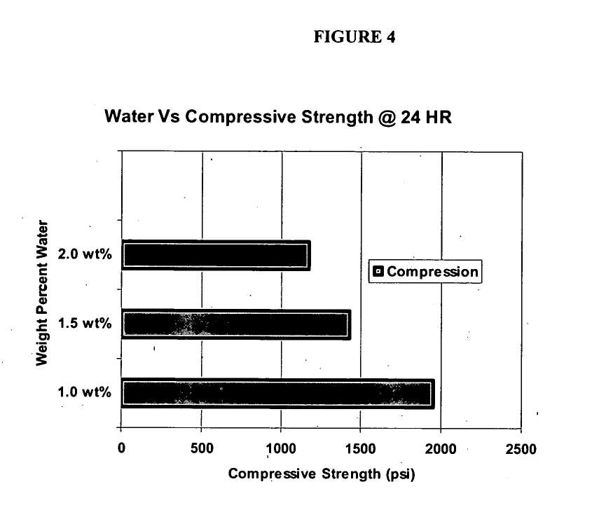

The procedure of Example 3 was carried out at a binder level of 15 weight percent using Manley 1L-5W. The level of water was increased from 1, 1.5, 2.0 weight percent. to determine the cure speed within 24 hours with increasing water level. As shown in FIG. 4, there appears to be minimal change in compressive strength with incremental increases in water.

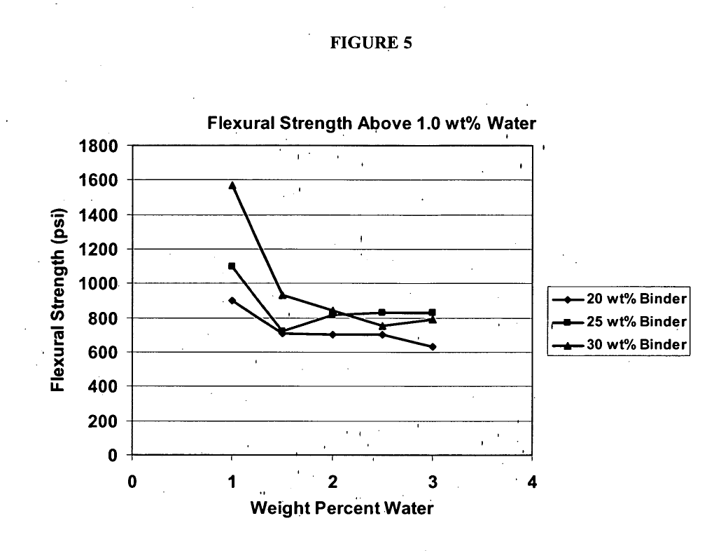

As with compressive strength measurements, flexural strength decreases (shown in FIG. 5) with increasing moisture and levels out at a given concentration of water; and at some point, increasing the binder level does not show additional improvement, which is evidently because all of the free isocyanate has completely reacted with the moisture.

We claim:

1. A process for filling a space comprising:
adding a binder composition to said space, where said binder is packaged as one-part and said binder composition comprises a polyisocyanate pre-polymer containing free isocyanate groups and an effective catalytic amount of a divalent metal catalyst, under conditions where sufficient moisture is present to cure said binder composition after it has been added to said space.

2. The process of claim 1 wherein said pre-polymer is the reaction product of a polyol and a polyisocyanate.

3. The process of claim 2 wherein the content of free isocyanate groups in said pre-polymer is from 9 to 14 percent.

4. The process of claim 3 wherein the polyol is selected from the group consisting of polyester polyols, polyether polyols, phenolic resole resins, and mixtures thereof.

5. The process of claim 4 wherein the moisture is present in the space to be filled or is added to the space to be filled prior to adding said space-filling composition.

6. The process of claim 5 wherein said binder composition further comprises an aggregate.

7. The process of claim 6 wherein said space to be filled contains an aggregate.

8. The process of claim 6 wherein the divalent metal catalyst is dibutyltindilaurate.

9. The process of claim 7 wherein the divalent metal catalyst is dibutyltindilaurate.

10. The process of claim 7 wherein the aggregate is selected from the group consisting of sand, crushed concrete, pea gravel, and rock.

11. The process of claim 10 wherein the amount of divalent metal catalyst is from 0.2 to 0.6 parts by weight based upon the parts by weight of the polyisocyanate pre-polymer.

12. The process of claim 11 wherein the amount of aggregate is from 50 to 95 parts by weight based upon 100 parts by weight of said binder.

13. The process of claim 12 wherein space to be filled is an opening in an airport runway.

14. The process of claim 1, 2, 3, 4, 5, 6, 7, 8, 9, 10, 11, 12, or 13 also contains a catalytically effective amount of a tertiary amine catalyst.

15. The process of claim 14 wherein the binder composition is solvent-free.

16. The process of claim 15 wherein the tertiary amine is selected from the group consisting of 2,2′-dimorpholinodiethylether and N,N′-dimethylpiperazine.
